(19) United States
(12) Patent Application Publication
(10) Pub. No.: US 2002/0122923 A1
(43) Pub. Date: Sep. 5, 2002

(54) Layered circuit boards and methods of production thereof

(76) Inventor: Stephen S. Ohr, Chippewa Falls, WI (US)

Correspondence Address: Honeywell International Inc., Law Dept. AB2, P.O. Box 2245, 101 Columbia Road, Morristown, NJ, 07962, US

(21) Appl. No.: 09/752,538

(22) Filed: Dec. 28, 2000

(51) Int. Cl. B32B 3/00; B32B 7/00

(52) U.S. Cl. 428/209; 29/846; 428/901; 428/458; 216/13

(57) ABSTRACT

Compositions and methods are provided whereby sublamination materials and layers may be produced that comprise a) a single layer etched reference plane having a top surface and a bottom surface; b) a first signal layer coupled to the top surface with a first bond-ply material; c) a second signal layer coupled to the bottom surface with a second bond-ply material; and d) at least one of a through via. Printed wiring boards may be produced that comprise a) a substrate layer, and b) a sublamination layer laminated onto the substrate layer, and c) at least one additional layer coupled to the sublamination layer or material.

### FIELD OF THE INVENTION

The field of the invention is electronic components.

### BACKGROUND OF THE INVENTION

Electronic components are used in ever increasing numbers of consumer and commercial electronic products. Examples of some of these consumer and commercial products are televisions, computers, cell phones, pagers, a palm-type organizer, portable radios, car stereos, or remote controls. As the demand for these consumer and commercial electronics increases, there is also a demand for those same products to become smaller and more portable for the consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging.

Components, therefore, are being broken down and investigated to determine if there are better building materials and methods that will allow them to be scaled down to accommodate the demands for smaller electronic components. In layered components, one goal appears to be decreasing the number or the size of the layers. This task can be difficult, however, given that several of the layers and components of the layers should generally be present in order to operate the component.

Thus, there is a continuing need to a) design and produce layered materials that meet customer specifications while minimizing the size and number of layers, and b) develop reliable methods of producing desired layered materials and components comprising those layered materials.

### SUMMARY OF THE INVENTION

Sublamination materials, lamination materials and layers may be produced that comprise a) a single layer etched reference plane having a top surface and a bottom surface; b) a first signal layer coupled to the top surface with a first bond-ply material; c) a second signal layer coupled to the bottom surface with a second bond-ply material; and d) at least one of a through via.

Printed wiring boards may be produced that comprise a) a substrate layer, and b) a sublamination layer laminated onto the substrate layer, and c) at least one additional layer coupled to the sublamination layer or material.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic diagram of a conventional two-layer sublamination material.

FIG. 2 is a schematic diagram of a preferred embodiment.

FIG. 3 is a flowchart showing a method of preparing a preferred embodiment.

FIG. 4 is a schematic diagram of a preferred embodiment.

Table 1 is a compilation of some preferred materials and their physical characteristics.

### DETAILED DESCRIPTION

Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up mock-up. A prototype may or may not contain all of the actual components intended in a finished product, and a prototype may have some components that are constructed out of composite material in order to negate their initial effects on other components while being initially tested.

Electronic products and components may comprise layered materials, layered components, and components that are laminated in preparation for use in the component or product. Sublamination layers or “sublam” layers generally make up the finished layered component or product.

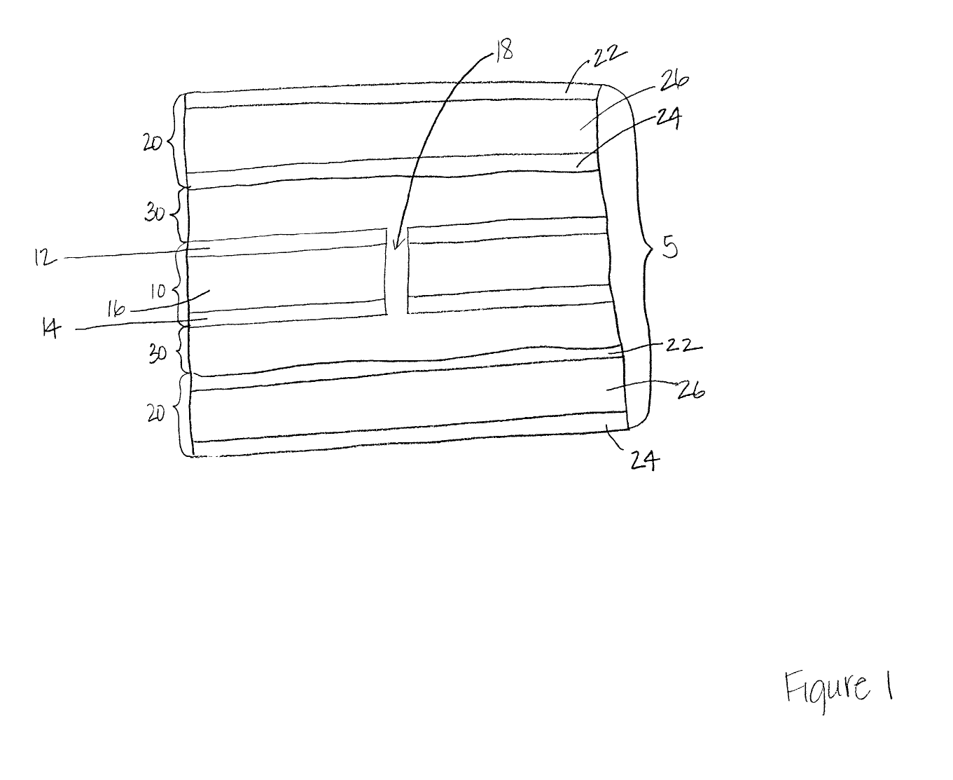

FIG. 1 shows a conventional two-layer sublamination layer 5 that may be used to build up a layered component or circuit board. The sublamination layer 5 comprises three distinct components: a) a signal pair layer 10, b) two reference layers or planes 20, and c) two layers of bond-ply or adhesive 30.

A conventional signal pair layer 10 generally comprises two signal layers 12 and 14 that are separated by a dielectric layer 16. The signal layers 12 and 14 generally comprise any conductive metal, such as copper or nickel. The signal layers 12 and 14 also have vias 18, or tiny holes, drilled through them and the dielectric material 16 in order to connect layers or to fill with conductive pastes or other materials. The dielectric material 16 functions to control signal integrity and can comprise any suitable dielectric material—whether continuous or porous.

The reference layers 20 in a conventional sublam layer 5 functions to control impedance from the closest signal layer. Each signal layer has a corresponding reference layer. In this example, the reference layers 20 comprise two layers of metal foil 22 and 24 and one layer of dielectric material 26. As with the signal layers 12 and 14, the metal foil layers 22 and 24 generally comprise any conductive metal, such as copper or nickel. The dielectric material can comprise any suitable dielectric material—whether continuous or porous.

The layers of bond-ply or adhesive 30 hold together the signal layer pair 10 with the reference layers 20. In general, the bond-ply material 30 can be any suitable tacky or adhesive material, however, in most embodiments, the bond-ply material is just an uncured state of the dielectric materials used in the signal layer pair 10 or the reference planes 20. Once the layers are assembled, the layered structure is cured and the bond-ply becomes another dielectric layer.

Although these conventional sublam layers have been functional, they are considered bulky and thicker than what is desirable for a scaled down component. The conventional sublam layers continue to be produced and used because the materials involved—i.e. preproduced signal pairs and reference planes—are thicker and easier to work with and assemble into boards. Further, quality control of lay-ups or boards comprising conventional sublam materials was difficult because with each layer of additional material came the possibility of defects or errors in the component, along with different thicknesses in several layers that were intended to be the same thickness.

As contemplated herein, sublamination layers or materials have been designed that allow a printed circuit board, in which the sublam layers are incorporated, to function with half as many reference planes when using dual strip line technology. Among other benefits, the use of the single reference plane contemplated herein will make it possible to delete one metal layer and two dielectric layers for each signal layer pair used in the lay-up. Further, the sublamination layers provided herein comprise initially an unsupported metal foil that is transformed into the single-layer etched reference plane. In the past, working with, etching and incorporating unsupported metal foils into components as reference planes was considered difficult, costly and generally not productive. Also, the production of a thinner circuit board will in turn allow the plated vias to be drilled at a smaller diameter—leading to a smaller pad stack and more area on the circuit board for additional signal lines. The additional signal lines will further allow designers to use devices with higher input/output counts.

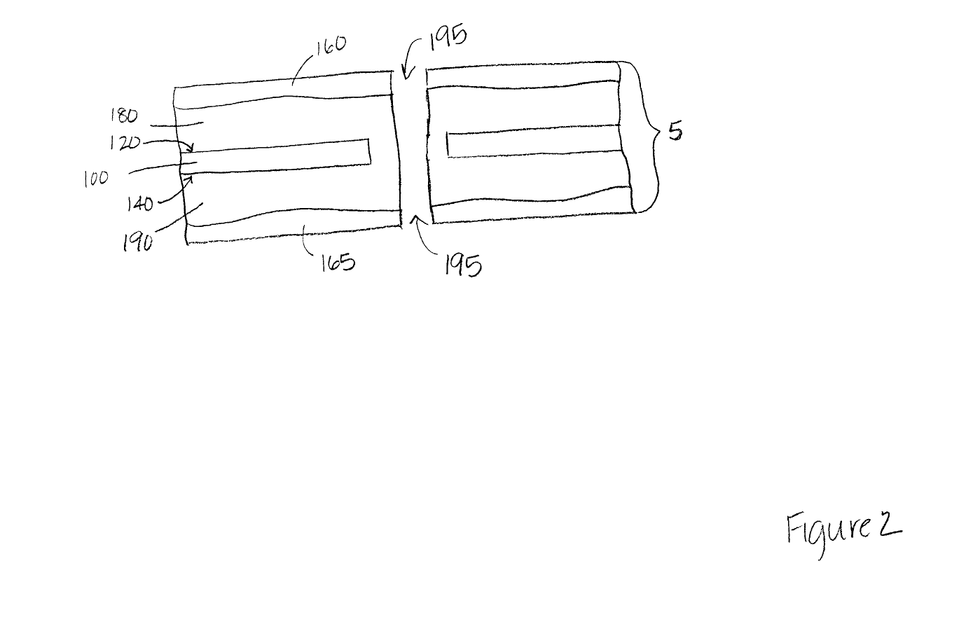

In FIG. 2, a sublamination layer 5 or “sublam” layer 5 contemplated herein comprises a) a single layer etched reference plane 100 having a top surface 120 and a bottom surface 140; b) a first signal layer 160 coupled to the top surface 120 with a first bond-ply material 180; c) a second signal layer 165 coupled to the bottom surface 140 with a second bond-ply material 190; and d) at least one of a through via 195.

The single layer, etched reference plane 100 replaces the conventional double-layer reference plane and is contemplated herein to comprise any suitable material that can also function to control impedance in the sublam layer 5. Generally, the reference plane 100 comprises a metal or other conductive material. As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include titanium, silicon, cobalt, copper, nickel, zinc, vanadium, aluminum, chromium, platinum, gold, silver, tungsten, molybdenum, cerium, promethium, and thorium. More preferred metals include titanium, silicon, copper, nickel, platinum, gold, silver and tungsten. Most preferred metals include titanium, silicon, copper and nickel. The term “metal” also includes alloys, metal/metal composites, metal ceramic composites, metal polymer composites, as well as other metal composites.

The single-layer, etched reference plane 100 can also be any suitable thickness, depending on the needs of the customer or the component. In a preferred embodiment, the reference plane 100 is not the same thickness as either the first signal layer 160 or the second signal layer 165. In more preferred embodiments, the reference plane 100 is thicker than the first signal layer 160 or the second signal layer 165. For example, in one preferred embodiment, the reference plane 100 is 2.1 mils thick, while the first signal layer 160 and second signal layer 165 are 1.5 mils thick. In some embodiments, it may also be advantageous for the first signal layer 160 and second signal layer 165 to have different thicknesses from one another.

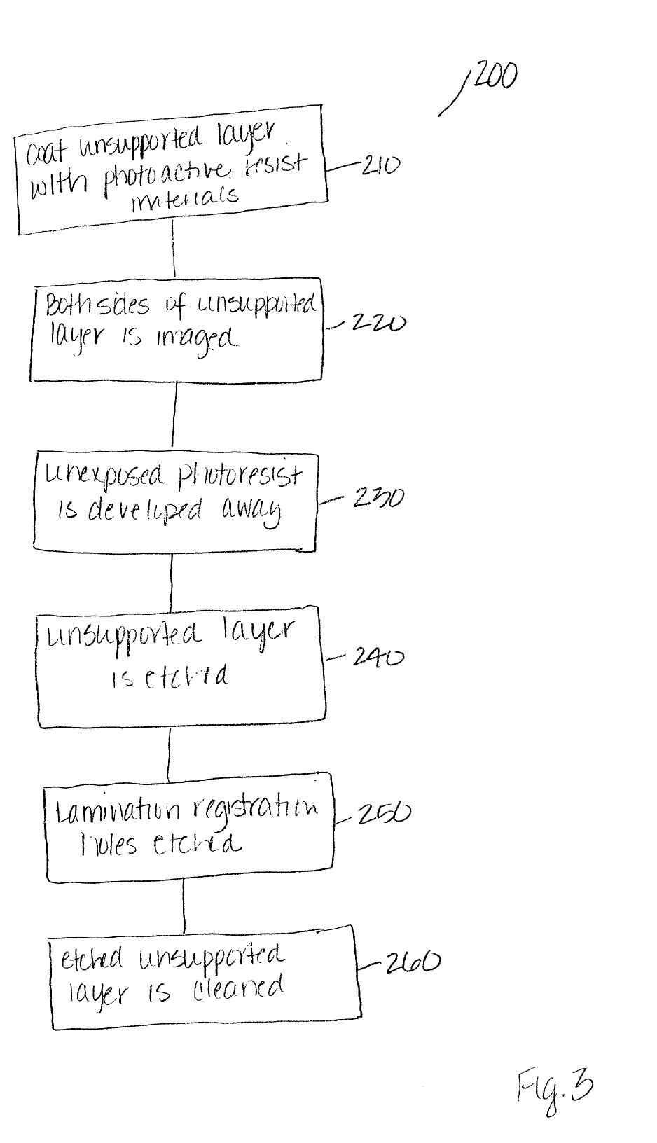

The single-layer reference plane 100 is also etched before introduction into the sublam layer 5. FIG. 3 shows a preferred method 200 of etching the single-layer reference plane 100. The single-layer reference plane 100 begins as a single layer of “unsupported” material—meaning that there are no layers or materials supporting the single layer at this stage. The single layer of unsupported layer is first coated with photoactive resist materials on both sides 210. Both sides of the unsupported layer are then exposed with the same image 220. Any unexposed photoresist material on the unsupported layer is developed away 230. The areas of the unsupported material that were exposed and thus not developed away are now etched completely through the unsupported material 240. Lamination registration holes are imaged on the unsupported material and etched 250. The etched unsupported material is cleaned 260 and now ready to be laminated 270 into the sublam layer 5 as the single-layer, etched reference plane 100.

The single-layer, etched reference plane 100 has a top surface 120 and a bottom surface 140. A bonding material, adhesive, or other material, such as “pre-preg” is attached to both the top surface 120 and the bottom surface 140 of the reference plane 100. Bonding material 180 is coupled to the top surface of the reference plane 100 and bonding material 190 is coupled to the bottom surface of the reference plane 100.

Bonding materials 180 and 190 may comprise any suitable adhesive, resin, laminate, bond-ply, polymer, monomer, or pre-preg material. It is contemplated that bonding materials 180 and 190 will act as a dielectric material once the sublam layer 5 is cured. In preferred embodiments, bonding materials 180 and 190 will comprise the same material. However, the component, customer or electronic product may require that bonding material 180 and 190 comprise different chemical compounds. In contemplated embodiments, the bonding materials 180 and 190 comprise FR4 epoxy, cyanate esters, polyimides, and glass reinforced compounds. In more preferred embodiments, the bonding materials 180 and 190 comprise one of FR4 or cyanate ester.

Contemplated polymers may also comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The molecular weight of contemplated polymers spans a wide range, typically between 400 Dalton and 400000 Dalton or more.

As used herein, the term “monomer” refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. Monomers may belong to various chemical classes of molecules including organic, organometallic or inorganic molecules. The molecular weight of monomers may vary greatly between about 40 Dalton and 20000 Dalton. However, especially when monomers comprise repetitive building blocks, monomers may have even higher molecular weights. Monomers may also include additional groups, such as groups used for crosslinking.

As used herein, the term “crosslinking” refers to a process in which at least two molecules, or two portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

The first signal layer 160 and the second signal layer 165 are contemplated to comprise materials similar to those discussed previously as suitable for single-layer, etched reference plane 100, including metals, metal alloys, metal composites, materials for producing optical components, such as wave-guides, and materials and compounds that can conduct electrons or photons. In preferred embodiments, the first signal layer 160 and the second signal layer 165 comprise copper or nickel. In other preferred embodiments the first signal layer 160 and the second signal layer 165 are the same material. However, it is contemplated that the signal layers may comprise different materials, if the needs of the customer, the component or the product require or demand that the two signal layers comprise different materials.

Once the single-layer, etched reference plane 100 is combined with the bonding materials 180 and 190 and then further combined with the first signal layer 160 and the second signal layer 165, the three-layered stack is cured at conditions prescribed by the type or types of bonding materials 180 and 190 that have been used in the stack. For example, FR4 may require a completely different temperature and pressure curing cycle than cyanate ester bond-ply.

Before the cured sublam layer 5 is incorporated into a layered component, through vias are drilled into the sublam layer 5. Through vias are tiny holes that are drilled directly through the two signal layers, the bonding materials and the etched clearance in the reference plane. These through vias 190 can be drilled either with conventional drilling tools, chemicals or with lasers. Through vias 190 are important for the layered components because they are used to interconnect layers, store other conductive materials and provide a foundation for other components in the component.

Although several different materials and preferred combinations have been previously described for the components of the sublamination layers 5, it should be realized that the composition of the sublam layer 5 is directly dependent on the needs of the customer, the component or the product. In order for the vendor of the sublam layer 5 to gauge the needs of the customer, the component and/or the product, the vendor must have a method of receiving as much information from the customer as possible.

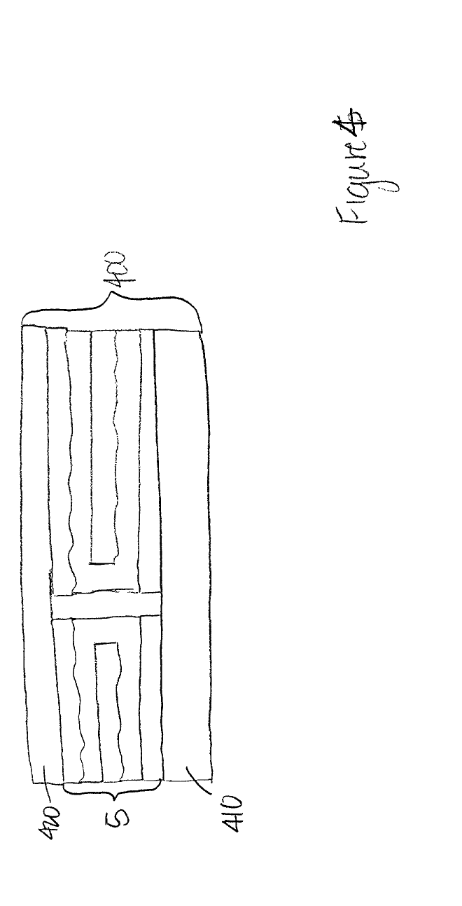

In FIG. 4, an electronic component 400 can be produced comprising the sublamination material 5 contemplated herein. The electronic component 400 comprises a) a substrate layer 410; b) a sublamination layer or sublamination material 5; and c) at least one additional layer 420.

Substrates and substrate layers 410, used herein interchangeably, contemplated herein may comprise any desirable substantially solid material. Particularly desirable substrate layers 410 would comprise films, glass, ceramic, plastic, metal or coated metal, or composite material. In preferred embodiments, the substrate 410 comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimides, BT, and FR4. In more preferred embodiments, the substrate 410 comprises a material common in the packaging and circuit board industries such as silicon, copper, glass, and another polymer.

Substrate layers 410 contemplated herein may also comprise at least two layers of materials. One layer of material comprising the substrate layer 410 may include the substrate materials previously described. Other layers of material comprising the substrate layer 410 may include layers of polymers, monomers, organic compounds, inorganic compounds, organometallic compounds, continuous layers and nanoporous layers.

The substrate layer 410 may also comprise a plurality of voids if it is desirable for the material to be nanoporous instead of continuous. Voids are typically spherical, but may alternatively or additionally have any suitable shape, including tubular, lamellar, discoidal, or other shapes. It is also contemplated that voids may have any appropriate diameter. It is further contemplated that at least some of the voids may connect with adjacent voids to create a structure with a significant amount of connected or “open” porosity. The voids preferably have a mean diameter of less than 1 micrometer, and more preferably have a mean diameter of less than 100 nanometers, and still more preferably have a mean diameter of less than 10 nanometers. It is further contemplated that the voids may be uniformly or randomly dispersed within the substrate layer. In a preferred embodiment, the voids are uniformly dispersed within the substrate layer 410.

Thus, it is contemplated that the substrate layer 410 may comprise a single layer of conventional substrate material. It is alternatively contemplated that the substrate layer 410 may comprise several layers, along with the conventional substrate material, that function to build up part of electronic component 400.

Suitable materials that can be used in additional substrate layers 410 comprise any material with properties appropriate for a printed circuit board or other electronic component, including pure metals, alloys, metal/metal composites, metal ceramic composites, metal polymer composites, cladding material, laminates, conductive polymers and monomers, as well as other metal composites.

A layer of laminating material or cladding material can be coupled to the substrate layer 410 or the sublamination layer 5 depending on the specifications required by the component. Laminates are generally considered fiber-reinforced resin dielectric materials. Cladding materials are a subset of laminates that are produced when metals and other materials, such as copper, are incorporated into the laminates. (Harper, Charles A., Electronic Packaging and Interconnection Handbook, Second Edition, McGraw-Hill (New York), 1997.)

Additional layers of material 420 may be coupled to the sublamination layer 5 in order to continue building a layered component or printed circuit board 400. It is contemplated that the additional layers 420 will comprise materials similar to those already described herein, including metals, metal alloys, composite materials, polymers, monomers, organic compounds, inorganic compounds, organometallic compounds, resins, adhesives and optical wave-guide materials.

If the results data set is to be displayed to the customer, then it can be converted into electronic format by “Web-enabling” the database or collection of databases. The term “Web-enabled” means that the database is accessible through or by the customer performing a set of commands at a Web browser or Web site, such as by accessing predetermined choices from a list box or via query language. The Web browser or Web site can be used to access a public network and/or private network, such as the Internet.

The results data set is preferably displayed or otherwise made available to the customer or made available to the customer within a relatively short period after the source data set is transmitted to the vendor. The results data set may advantageously be made available to the customer within 72 hours of the customer inputting the source data, more preferably within 36 hours, and even more preferably within 24 hours.

The vendor and the customer, at this point, can review the results data set and decide on the production specifications of the layered components incorporating the sublamination and layered materials. The results data set can aid the vendor and customer in deciding which production method will be more appropriate and meet the cost needs of the customer.

### EXAMPLE

Manufacture Copper Reference Plane

Use copper weight required by customer for current carrying capacity requirement. Test vehicles have been run using 1 ½-oz (1.8 mil) copper. However, depending on application either lighter or heavier copper weights can be substituted.

Coat copper foil both sides with photo resist. Expose both sides with same image defining via hole clearances. Develop both sides exposing copper to be etched. Etch clearances for via holes. Strip photo resist both sides, and layup etched copper reference planes between dielectric bond plies and outer copper foils. The following layer specifications were used in this case:

⅛ oz to ½ oz copper foil (Signal layer)

Dielectric bond ply

Etched reference plane

Dielectric bond ply

⅛ oz to ½ oz copper foil (Signal layer)

Preparation of Sublamination Material or Layers

Laminate etched reference plane between dielectric material and outer layer copper foil as shown above. The lamination cycle will vary depending of the type dielectric that is chosen. (See Table 1 below)

TABLE 1
Dielectric bond ply materials to be used but limited to in the
three layer buried via layer

| | | | | lamination | lamination |
|---|---|---|---|---|---|
| Tg | material | material | lamination | temperature | pressure |
| Celsius | type | base | dwell | Celsius | (PSI) |
| 140 | FR4 | glass | 45 | 177 | 250 |
| | epoxy | reinforced | minutes | degrees | |
| 170 | FR4 | glass | 80 | 182 | 250 |
| | epoxy | reinforced | minutes | degrees | |
| 170 | FR4 | resin coated | 80 | 182 | 250 |
| | epoxy | foil * | minutes | degrees | |
| 180 | BT | glass | 80 | 191 | 350 |
| | (triazine/ | reinforced | minutes | degrees | |
| | bism | | | | |
| | alemide) | | | | |
| 190 | Asahi | PPO | 80 | 182 | 350 |
| | | | minutes | | |
| 190 | Cyanate | glass | 80 | 191 | 350 |
| | ester | reinforced | minutes | degrees | |
| 190 | Cyanate | Teflon | 80 | 191 | 350 |
| | ester | (Speedboard) | minutes | degrees | |
| 260 | polyimide | glass | 120 | 218 | 350 |
| | | reinforced | minutes | degrees | |
| 297 ** | LCP | Film | 30 | 273 | 500 |
| | | | minutes | degrees | |

* stackup would include dielectric and copper as one
** Melt temp.

Remove excess flash from lamination resin flow. Register tooling holes to layer 2 images for drilling by laser exposing fiducials. Drill via holes either by conventional drill bit method or by laser method. All holes must fall within etched clearances in reference plane. Hole prep in permanganate. Electroless copper plate panel. Coat panel with photoimagible resist. Expose using pattern plate image polarity on layer 1 and layer 3. Develop away-unwanted photo resist. Copper pattern plate panel. Tin pattern plate panel. Strip photo resist. Alkaline etch features to required sizes. Strip Tin from copper features. Automatic optical inspect signal layers. Include “three layer buried vias” in with rest of layers to be laminated into final board.

Thus, specific embodiments and applications of electronic components comprising sublamination materials have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A sublamination layer, comprising:
a single layer etched reference plane having a top surface and a bottom surface;
a first signal layer coupled to the top surface with a first bond-ply material;
a second signal layer coupled to the bottom surface with a second bond-ply material; and
at least one of a through via.

2. The sublamination layer of claim 1, wherein the single layer etched reference plane comprises a metal.

3. The sublamination layer of claim 2, wherein the metal is copper or nickel.

4. The sublamination layer of claim 1, wherein the first bond-ply material and the second bond-ply material comprise a same materials.

5. The sublamination layer of claim 4, wherein the same material is FR4 or cyanate ester.

6. The sublamination layer of claim 1, wherein the first bond-ply material and the second bond-ply material do not comprise a same material.

7. An electronic component comprising the sublamination layer of claim 1.

8. The electronic component of claim 7, wherein the electronic component is a printed circuit board.

9. An electronic product comprising the sublamination layer of claim 1.

10. A method of producing a sublamination layer, comprising
providing an unsupported layer of material having a top side and a bottom side;
applying a photoactive resist to the top side and the bottom side of the material;
exposing the top side and the bottom side with a light image;
removing the photoactive resist material that is not exposed;
etching the unsupported layer of material;
cleaning the unsupported layer of material;
coupling a bonding material to the top side and bottom side of the unsupported layer;
coupling a first signal layer to the bonding material coupled to the top side; and
coupling a second signal layer to the bonding material coupled to the bottom side.

11. The method of claim 10, wherein the unsupported layer of material comprises a metal.

12. The method of claim 11, wherein the metal is copper or nickel.

13. The method of claim 11, wherein the bonding material is FR4 or triazine/bismalemide.

14. A method for producing an electronic component, comprising:
providing a substrate;
coupling at least one sublamination material to the substrate; and
coupling at least one additional layer to the sublamination material.

15. The method of claim 14, wherein the substrate is a silicon wafer.

16. The method of claim 14, wherein the sublamination material is the sublamination material of claim 1.

17. The method of claim 14, wherein the additional layer is a laminate.

18. The method of claim 14, wherein the electronic component comprises a printed circuit board.
